(19) United States
(12) Patent Application Publication
(10) Pub. No.: US 2022/0082318 A1
(43) Pub. Date: Mar. 17, 2022

(54) REFRIGERATOR

(71) Applicant: BSH Hausgeraete GmbH, Muenchen (DE)

(72) Inventors: Wei Cheng, Chuzhou (CN); Shili Huang, Chu zhou (CN)

(21) Appl. No.: 17/470,072

(22) Filed: Sep. 9, 2021

(30) Foreign Application Priority Data
Sep. 15, 2020 (CN) 202010966494.4

(51) Int. Cl. F25D 23/02

(52) U.S. Cl. CPC F25D 23/028

(57) ABSTRACT

A door for a refrigerator includes an accommodating portion; a user-interface electrical module, at least partially located in the accommodating portion; a front panel, covering the front of the user-interface electrical module; a handle groove, the handle groove and the accommodating portion being adjacent in a depth direction of the handle groove; and a gripping portion, located in front of the handle groove. The gripping portion includes a decoration portion and a base portion located behind the front panel, and the decoration portion and the front panel are adjacent in the depth direction of the handle groove and are exposed on a front side of the door.

### CROSS-REFERENCE TO RELATED APPLICATION

This application claims the priority, under 35 U.S.C. § 119, of Chinese patent application CN 202010966494.4, filed Sep. 15, 2020; the prior application is herewith incorporated by reference in its entirety.

### FIELD AND BACKGROUND OF THE INVENTION

The present invention relates to a refrigerator, and in particular, to a refrigerator with a handle groove on a door.

One way to dispose a short handle on a door of a refrigerator is to use a plastic injection molded part. Surface treatment needs to be performed on the injection molded part through a process such as spraying, hot stamping, or electroplating, to produce a beautiful effect or to match the overall appearance of the refrigerator. To ensure that the strength of the plastic handle can meet requirements, it is necessary to mount a metal reinforcing member inside the handle to enhance the strength of the handle.

### BRIEF SUMMARY OF THE INVENTION

An objective of the present invention is to provide an improved refrigerator.

Embodiments of the present invention relate to a refrigerator, including a door, where the door includes: an accommodating portion; a user-interface electrical module, at least partially located in the accommodating portion; a front panel, covering the front of the user-interface electrical module; a handle groove, the handle groove and the accommodating portion being adjacent in a depth direction of the handle groove; and a gripping portion, located in front of the handle groove in a width direction of the handle groove. The gripping portion includes a decoration portion and a base portion located behind the front panel, the decoration portion and the front panel are adjacent in the depth direction of the handle groove and are exposed on a front side of the door, the front panel includes a first region covering the accommodating portion and a second region covering the base portion, and the decoration portion, the second region, and the first region are arranged side by side in the depth direction of the handle groove.

In this embodiment, the user-interface electrical module and handle-related elements can be concentrated in one region of a door of a refrigerator, so that more choices and possibilities can be provided for manufacturing of the refrigerator, which is beneficial to reducing restrictions on the structures or manufacturing of the refrigerator, for example, a handle groove only extends along a partial height/width of a door.

The decoration portion is exposed on the front side of the door, which not only can decorate a refrigerator, but also can produce a prompting or indicating effect to indicate a position of the handle groove, thereby improving the recognition of the handle, and allowing a user to quickly and accurately operate the handle groove to open the door of the refrigerator.

The decoration portion and the front panel are adjacent in the depth direction of the handle groove and are exposed on a front side of the door, which is beneficial to reducing restrictions of the front panel on the shape or structure of the decoration portion, thereby providing more choices and possibilities for the improvement or adjustment of the handle. For example, the thickness of the decoration portion in a front and back direction of the front panel may break through the restrictions of the front panel to be greater, to provide a better gripping feel for a user.

In this embodiment, when an operator opens or closes the door of the refrigerator, the thumb and the fingers located in the handle groove touch the gripping portion in most cases, so that all the fingers obtain a consistent touch and feel, thereby improving operating experience of a user.

In addition, for a front panel made of glass, an edge portion of the front panel is often a weaker portion of the front panel due to stress concentration. The decoration portion of this embodiment can protect the edge of the front panel, which is beneficial to reducing the probability that the front panel at the handle groove is cracked by impact. After all, the handle groove is the portion of the refrigerator most frequently touched by a user, so that this embodiment reduces the risk of injury to the user.

In one or more possible embodiments, the refrigerator includes a door liner, a front wall, and a side wall located between the door liner and the front wall, where the door liner, the front wall, and the side wall define a thermal insulation space, and the thermal insulation space is filled with a thermal insulation layer. The door further includes a user-interface housing combined with the thermal insulation layer (e.g. the thermal insulation layer is directly contacting and/or adhering to the user-interface housing), the accommodating portion is located in the user-interface housing, the front wall includes a first opening, the side wall includes a second opening in communication with the first opening, the user-interface housing closes the first opening and the second opening relative to the thermal insulation layer, the user-interface housing includes a recess open toward the first opening and the second opening, the recess is used for accessing the handle groove located in the user-interface housing, and the decoration portion extends along a whole length of the first opening.

In this embodiment, the user-interface electrical module and handle-related elements can be concentrated in the user-interface housing. The user-interface housing not only can prevent foaming liquid leakage in the thermal insulation layer of the door during foaming, but also can be formed independently of the front wall and the side wall, which provides more possibilities or convenience for manufacturing of the refrigerator. For example, the side wall and the front wall can be formed as a one-piece structure, for example, formed by a thin metal plate. In another example, even if the handle groove only extends along the partial height/width of the door, the side wall can also be formed by extrusion. The decoration portion extends along the whole length of the first opening, which can improve the integrity of the door.

In one or more possible embodiments, the recess, the decoration portion, and the front panel are arranged side by side in the depth direction of the handle groove. Therefore, the recess for a hand to access the handle groove and the handle groove are compactly arranged in the user-interface housing, so that a gap reserved between two adjacent doors of the refrigerator for a hand of an operator to enter may be omitted. The two adjacent doors may be disposed closer to greatly reduce the distance between the two doors, which is beneficial to improving the integrity of the front of the refrigerator.

In one or more possible embodiments, the user-interface housing includes a first rear wall combined with the thermal insulation layer, and the first rear wall faces the handle groove and forms a rear boundary of the handle groove. If the handle member alone forms the rear boundary of the handle groove, the handle member occupies more thermal insulation space, which degrades the thermal insulation effect of the door body. This embodiment is beneficial to reducing the occupation of the thermal insulation space by the handle groove.

In one or more possible embodiments, the first region of the front panel is provided with at least one display region, the display region is set to be more transparent than the remaining part of the front panel, and a length extension direction of the display region or an arrangement direction of a plurality of display regions is consistent with a length direction in which the decoration portion is exposed on the front side of the door. This embodiment is beneficial to making the arrangement of the user-interface electrical module and the decoration portion more compact, is beneficial to reducing the sizes of the user-interface electrical module and the handle groove in another dimension of the door, and is further beneficial to reducing the size of the housing accommodating the user-interface electrical module and the handle groove in width, thereby reducing the occupation of the thermal insulation space, which is beneficial to improving the thermal insulation effect of the door body. In addition, this embodiment is beneficial to making the appearance of the door of the refrigerator more consistent in a use state.

In one or more possible embodiments, the decoration portion includes an external plane exposed on the front side of the door, and the external plane is flush with a front surface of the second region and a front surface of the first region. Therefore, the front surface of the door of the refrigerator is leveled to provide a smooth touch and feel for a user. The smooth front surface is easier to clean and less likely to accumulate dust.

The size of the decoration portion in the depth direction of the handle groove is not less than 20 mm. In this embodiment, an operator opens and closes the door of the refrigerator, it is further ensured that the thumb and fingers located in the handle groove all touch the gripping portion, so that all the fingers obtain a consistent touch and feel, and touch the same material with the same flatness, thereby further improving operating experience of a user. From another perspective, this embodiment greatly reduces a probability that a finger touches the front panel of the door, and reduces a probability of leaving a fingerprint on the front panel, which is beneficial to keeping the cleanliness of the front panel.

In one or more possible embodiments, the door includes a front door panel facing a user, the front door panel includes a notch extending to an outer edge of the front door panel, the notch extends along a partial length or width of the front door panel, and the decoration portion is located in the notch, extends along a whole length of the notch, and fills at least a part of the notch. Therefore, the decoration portion can protect at least a part of the edge of the front door panel in the notch, which is beneficial to reducing processing requirements of the edge at which the front door panel and the decoration portion joint.

In one or more possible embodiments, a part of the front door panel is constructed as the front panel, the front door panel includes a first edge and a second edge that are disposed in parallel and spaced apart, and a third edge connecting the first edge and the second edge, the first edge and the second edge respectively constitute two boundaries of the notch in a length direction of the notch, the third edge constitutes a boundary of the notch in a width direction of the notch, and the decoration portion extends along the third edge, and is respectively spliced (e.g. joined or connected) with the first edge, the second edge, and the third edge. Therefore, this embodiment is beneficial to improving the integrity of the front door panel. The decoration portion prevents the third edge from being exposed, is beneficial to reducing processing requirements of the third edge, and can also reduce the risk of the brittle front door panel, such as a glass front door panel, being cracked by impact at the third edge.

In one or more possible embodiments, the door further includes the user-interface housing combined with the thermal insulation layer of the door, the user-interface housing includes an accommodation space in communication with the accommodating portion located in the user-interface housing, and the user-interface electrical module is mounted or taken out through the accommodation space; and the door further includes a cover portion configured to close the accommodating portion, the cover portion is connected to the base portion, and the cover portion and the gripping portion are constructed as a one-piece member detachably mounted in the accommodation space. Therefore, the user-interface electrical module and handle-related components may be mounted after foaming is completed in the thermal insulation layer of the door. After the refrigerator is manufactured, the user-interface electrical module may be maintained or replaced later by disassembling the one-piece member formed by the cover portion and the gripping portion.

In one or more possible embodiments, the gripping portion and the cover portion are constructed as a one-piece metal member.

In the related art, to ensure that the strength of the plastic handle can meet requirements, it is necessary to mount a metal reinforcing member inside the handle to enhance the strength of the handle, resulting in high structural complexity of the handle and more mounting steps. For example, a one-piece metal member formed by extruding aluminum or stainless steel through molds can meet requirements of structural strength, and no additional reinforcing member needs to be mounted, thereby reducing the complexity of the handle structure and simplifying the mounting steps of the handle.

In addition, the temperature of a mold cavity for injection molding of a plastic member is up to 200° C. or more, and the plastic member is prone to shrinkage, resulting in an uneven surface. Moreover, the plastic handle undergoes surface treatment including a plurality of processes, resulting in a relatively high scrap rate of plastic injection-molded handles. In a process of manufacturing a metal member, the straightness is easier to control, which reduces the complexity of manufacturing of the handle, and greatly reduces the scrap rate of handle products.

The surface of the decoration portion exposed on the front side of the door may be directly subjected to surface treatment such as wire drawing, etching, or printing. The surface treatment is easier to control, leading to a high yield rate. The metal decoration portion can show a sense of quality of precision processing. When used on a household appliance, the metal decoration portion helps to enhance the texture and the design sense of the entire household appliance, thereby improving the recognition of a product.

In one or more possible embodiments, the base portion includes a protrusion protruding toward the front panel, and the protrusion engages the third edge and abuts against the front panel. Therefore, the height difference between the protrusion and the external plane of the decoration portion exposed on the front side of the door is equal to the thickness of the front panel, which is beneficial to controlling an effect that the external plane of the decoration portion is flush with the front surface of the front panel. In the process of mounting the handle, the handle member is pushed inward while keeping the protrusion in contact with the inner surface of the front panel. The protrusion engages the third edge and abuts against the front panel, thereby effectively reducing a stroke for contact between the protrusion and the front panel, which is beneficial to reducing a possibility that the protrusion scratches the front panel and reducing the scratch area, for example, reducing the possibility of a metal protrusion scratching the paint on an inner surface of a glass front panel, and reducing the scratch area.

In one or more possible embodiments, the protrusion extends along a partial length of the handle groove, and the base portion is provided with an avoidance region on each of two ends of the protrusion. In the avoidance region, a gap is kept between the front panel and the base portion in an extending direction of the protrusion.

During foaming, the temperature of the door may reach 70° C. or more. For a door of a freezing compartment of the refrigerator, the temperature inside the door may reach—18° C. or even lower. Due to the temperature difference effect, the front panel covering the front of the user-interface electrical module is deformed to some extent, and regions of two ends of the front panel in the length direction of the handle groove are bent and deformed toward the direction of the handle groove. To reduce interference with the deformed portion of the front panel, the base portion is provided with the avoidance regions on the two ends of the protrusion.

In one or more possible embodiments, the size of the avoidance region in the length direction of the handle groove is 30 mm.

In one or more possible embodiments, the decoration portion includes the external plane exposed on the front side of the door, and a baffle wall substantially perpendicular to the external plane, and the baffle wall abuts against the third edge. The baffle wall abuts against the third edge, making it more convenient to determine whether the handle member is mounted in place in the process of mounting the handle member.

In one or more possible embodiments, the decoration portion is constructed as a hollow decoration portion. On the premise that the strength of the handle meets requirements, this embodiment is beneficial to saving materials and reducing costs.

In one or more possible embodiments, the cover portion includes a mounting portion, the mounting portion is formed with a cavity and includes a first mounting wall and a second mounting wall that are disposed opposite to each other and spaced apart, and a connection member passes through the first mounting wall, the cavity, and the second mounting wall to mount the cover portion to the user-interface housing. Therefore, this embodiment can increase a total stroke for the connection member to cooperate with the cover portion, which is beneficial to improving the stability and firmness of the connection between the two. In addition, in this embodiment, a force of pressing the cover portion in the depth direction of the handle groove in the process of mounting the handle is dispersed through the cavity. The second mounting wall is configured to directly or indirectly abut against the user-interface housing, and the second mounting wall transfers the force of pressing the cover portion to the user-interface housing more dispersedly, which is beneficial to reducing the risk of causing damage to related components in the mounting process.

In one or more possible embodiments, the door further includes an intermediate element disposed between the cover portion and the user-interface housing, a sealing member is disposed on a part of the intermediate element facing the front panel, and the connection member passes through the mounting portion and the intermediate element to be connected to the user-interface housing. This embodiment can reduce the possibility that water vapor or dust enters the accommodating portion to affect the function of the user-interface electrical module.

In one or more possible embodiments, the front panel is a one-piece front panel, the front panel is spliced with the front door panel to close most of the notch, and the decoration portion extends along an edge of the front panel. Therefore, this embodiment keeps, to a large extent, the integrity of the door exposed on the front side. In addition, the decoration portion can protect the edge of the front panel, thereby effectively reducing the possibility of damage to the edge of the front panel due to impact or a hit. Due to the protection of the decoration portion, the processing requirements for at least a part of the edge of the front panel can be reduced.

In one or more possible embodiments, the door further includes the user-interface housing combined with the thermal insulation layer of the door, and the user-interface housing is integrally formed with the base portion and the decoration portion. Therefore, in the present invention, the structure and the mounting are further simplified, and the step of separately mounting a handle member is omitted.

In one or more possible embodiments, a decoration strip exposed on the front side of the door is disposed on the decoration portion. The decoration strip may be a film, a coating, or a plating on the surface of the decoration portion, or the decoration strip may be a metal strip attached to the surface of the decoration portion. Therefore, there are more choices for the material and disposition of the decoration strip.

In one or more possible embodiments, the decoration strip is a one-piece metal decoration strip. For example, the metal decoration strip may be disposed on the decoration portion in a sticking or pasting manner.

It should be noted that, features of dependent claims may be combined with each other in any way and with features of independent claims without departing from the concept of the present invention.

Other features which are considered as characteristic for the invention are set forth in the appended claims.

Although the invention is illustrated and described herein as embodied in refrigerator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic three-dimensional diagram of a door of a refrigerator according to an embodiment of the present invention;

FIG. 2 is a front view of a door of a refrigerator according to an embodiment shown in FIG. 1;

FIG. 3 is an enlarged view of a region III in FIG. 2;

FIG. 4 is a partial cross-sectional view along a line IV-IV in FIG. 2;

FIG. 5 is a partial cross-sectional view along a line V-V in FIG. 2;

FIG. 6 is a three-dimensional diagram of a handle member according to an embodiment of the present invention;

FIG. 7 is a three-dimensional diagram of a handle member from another perspective according to an embodiment of the present invention;

FIG. 8 is a schematic diagram of a cross section of a handle member according to an embodiment of the present invention;

FIG. 9 is a schematic diagram of a front wall, a side wall, and a user-interface housing according to another embodiment of the present invention; and

FIG. 10 is a partial cross-sectional view of a door of a refrigerator according to another embodiment of the present invention.

### DETAILED DESCRIPTION OF THE INVENTION

For a further understanding of the objectives, structures, features, and functions of the present invention, a detailed description is made below with embodiments.

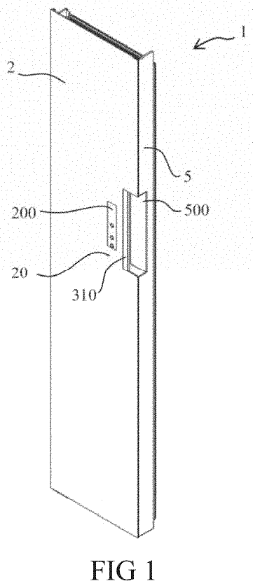

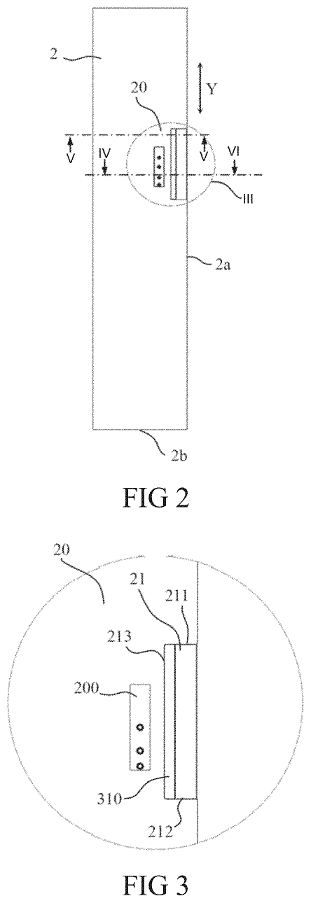

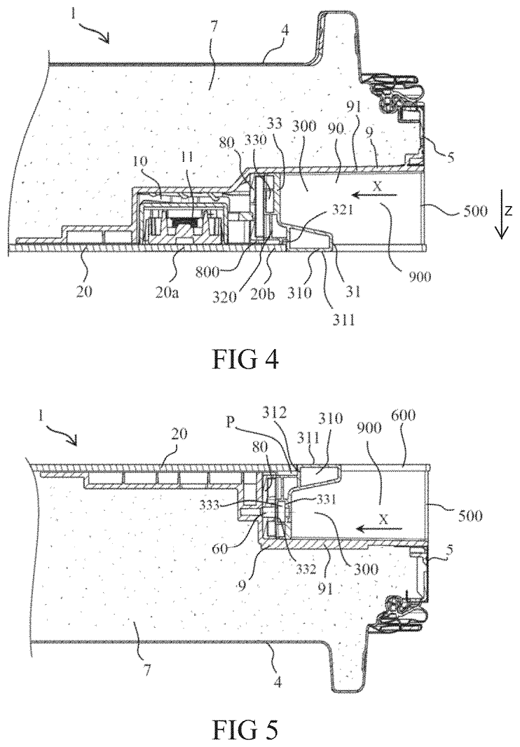

First, refer to FIG. 1 to FIG. 5. FIG. 1 is a schematic three-dimensional diagram of a door of a refrigerator according to an embodiment of the present invention; FIG. 2 is a front view of a door of a refrigerator according to an embodiment shown in FIG. 1; FIG. 3 is an enlarged view of a region III in FIG. 2; FIG. 4 is a partial cross-sectional view along a line IV-IV in FIG. 2; and FIG. 5 is a partial cross-sectional view along a line V-V in FIG. 2.

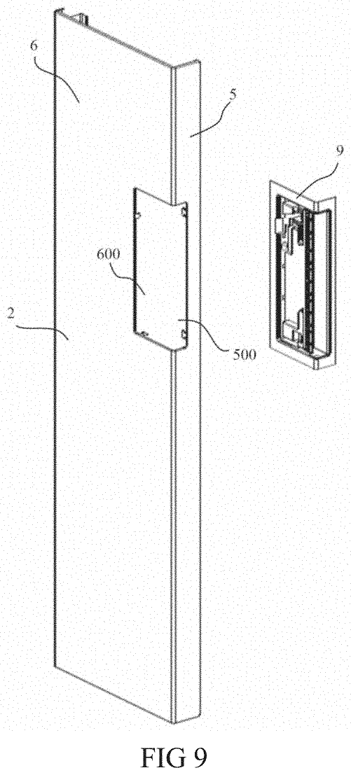

In this embodiment, a refrigerator includes a door 1. The door is configured to close or open a storage compartment of the refrigerator. The door 1 includes a door liner 4, a front wall 6, and a side wall 5 located between the door liner 4 and the front wall 6. The door liner 4, the front wall 6, and the side wall 5 define a thermal insulation space. The thermal insulation space is filled with a thermal insulation layer 7. The front wall is not shown in FIG. 1 to FIG. 5, referring to FIG. 9. The door 1 further includes a front door panel 2 disposed on the front of the front wall 6. In this embodiment, the front door panel 2 is formed by a whole piece of glass extending along the entire height of the door 1 and can be touched by a user in a use state.

Referring to FIG. 4 and FIG. 5, the door 1 of the refrigerator includes an accommodating portion 10, a user-interface electrical module 11, a front panel 20, a handle groove 300, and a gripping portion 31. The user-interface electrical module 11 is at least partially located in the accommodating portion 10. The front panel 20 covers the front of the user-interface electrical module 11. In this embodiment, the front panel 20 is formed by a part of the front door panel 2. The handle groove 300 and the accommodating portion 10 are adjacent in a depth direction (the X direction shown in FIG. 4 and FIG. 5) of the handle groove 300.

The gripping portion 31 is located in front of the handle groove 300 (in a width direction of the handle groove). The gripping portion 31 includes a decoration portion 310 and a base portion 320 located behind the front panel 20. The decoration portion 310 and the front panel 20 are adjacent in the depth direction of the handle groove 300 and are exposed on a front side of the door 1. The front panel 20 includes a first region 20a covering the accommodating portion 10 and a second region 20b covering the base portion 320. The decoration portion 310, the second region 20b, and the first region 20a are arranged side by side in the depth direction (the X direction shown in FIG. 4 and FIG. 5) of the handle groove 300.

In this embodiment, the size of the decoration portion 310 in the depth direction of the handle groove 300 is not less than 20 mm. As shown in FIG. 1 and FIG. 2, the decoration portion 310 is exposed on the front side of the door and can indicate a position of the handle groove 300, thereby improving the recognition of the handle.

When a user opens or closes the door, in most cases, the thumb touches the decoration portion 310, and the fingers located in the handle groove 300 touch the decoration portion 310 or the decoration portion 310 and the base portion 320. That is, in most cases, the user touches the gripping portion 31, so that the fingers located inside and outside the handle groove 300 obtain a consistent touch and feel. This can help eliminate a sense of shaking or a gap that is caused by manufacturing or assembly tolerances and that may be felt when an assembly of different components is gripped with force.

Specifically, in this embodiment, the door 1 further includes a user-interface housing 9 combined with the thermal insulation layer 7, and the accommodating portion 10 is located in the user-interface housing 9. The user-interface housing 9 is, for example, manufactured from plastics through injection molding. The user-interface housing 9 includes a first rear wall 91 combined with the thermal insulation layer 7, and the first rear wall 91 faces the handle groove 300 and forms a rear boundary of the handle groove 300. An inner surface of the gripping portion 31 forms a front boundary of the handle groove 300.

Specifically, the front wall (referring to the front wall 6 in FIG. 9) includes a first opening 600, the side wall 5 includes a second opening 500 in communication with the first opening 600, and the user-interface housing 9 closes the first opening 600 and the second opening 500 relative to the thermal insulation layer 7. The user-interface housing 9 includes a recess 900 open toward the first opening 600 and the second opening 500, and the recess 900 is configured to access the handle groove 300 located in the user-interface housing 9. The decoration portion 310 extends along the whole length of the first opening 600. The recess 900, the decoration portion 310, and the front panel 20 are arranged side by side in the depth direction of the handle groove 300. In this embodiment, the front door panel 2 is attached to the front of the front wall, so that the front panel 20 formed by a part of the front door panel 2 covers the accommodating portion 10 and the base portion 320 of the gripping portion 31.

The user-interface housing 9 includes an accommodation space 90 in communication with the accommodating portion 10 located in the user-interface housing 9. In this embodiment, the user-interface electrical module 11 can be mounted or taken out through the accommodation space 90. The door 1 further includes a cover portion 33 configured to close the accommodating portion 10. The cover portion 33 is connected to the base portion 320, and the cover portion 33 and the gripping portion 31 are constructed as a one-piece member detachably mounted in the accommodation space 90, that is, the handle member 30.

In this embodiment, the process of manufacturing the door 1 is as follows: the door liner 4, the front wall 6, and the side wall 5 define a thermal insulation space, and a thermal insulation material is injected into the thermal insulation space to form the thermal insulation layer 7. The door liner 4, the front wall 6, the side wall 5, and the thermal insulation layer 7 are combined and fixed together. The user-interface housing 9 is connected to the front wall 6 and the side wall 5 in advance, and the user-interface housing 9 is combined with the thermal insulation layer 7 to be fixed to the door 1 during foaming of the door. The front door panel 2 is disposed on the front of the front wall 6 in a pasting manner. The user-interface electrical module 11 is then mounted through the accommodation space 90 into the accommodating portion 10 located in the user-interface housing 9, and then the handle member 30 is mounted, to close the accommodating portion 10. Therefore, after the refrigerator is manufactured, the user-interface electrical module 11 can be replaced or repaired by disassembling the handle member 30 without damaging the door 1.

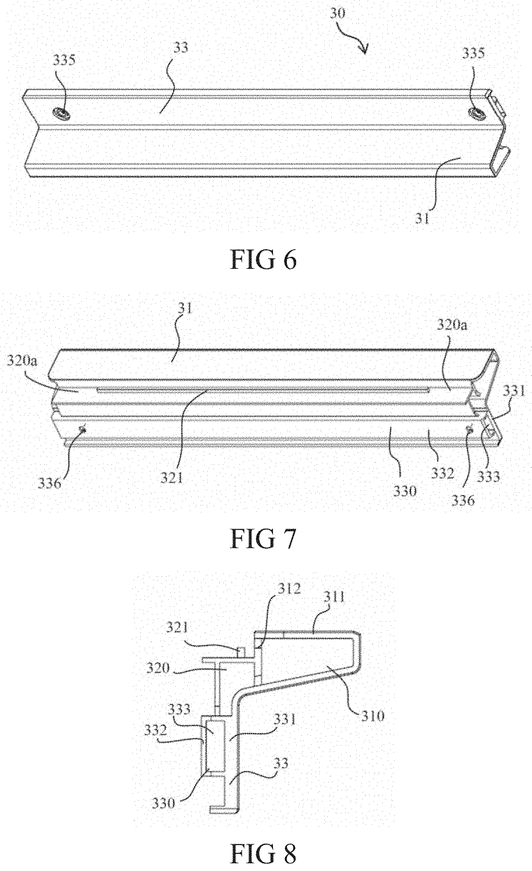

In this embodiment, refer to FIG. 6 to FIG. 8 for the structure of the handle member 30. FIG. 6 is a three-dimensional diagram of a handle member according to an embodiment of the present invention; FIG. 7 is a three-dimensional diagram of a handle member from another perspective according to an embodiment of the present invention; and FIG. 8 is a schematic diagram of a cross section of a handle member according to an embodiment of the present invention. In this embodiment, the gripping portion 31 and the cover portion 33 are constructed as a one-piece metal member, that is, the handle member 30 is a one-piece metal member. In this embodiment, the handle member 30 is formed by extruding aluminum through molds. In other embodiments, the handle member 30 may be a one-piece stainless steel member or a one-piece member made of another metal.

As shown in FIG. 2, the front door panel 2 includes a notch 21 extending to an outer edge 2a of the front door panel 2, and the notch 21 extends along a partial length of the front door panel 2. The decoration portion 310 is located in the notch 21, extends along a whole length of the notch 21, and fills at least a part of the notch 21. In this embodiment, the decoration portion 310 fills at least a part of the notch 21.

As described above, in this embodiment, a part of the front door panel 2 is constructed as the front panel 20. As shown in FIG. 3, the front door panel 2 includes a first edge 211, a second edge 212, and a third edge 213 connecting the first edge 211 and the second edge 212. The first edge 211 and the second edge 212 are disposed in parallel and spaced apart. The first edge 211 and the second edge 212 respectively constitute two boundaries of the notch 21 in a length direction of the notch 21, the third edge 213 constitutes a boundary of the notch 21 in a width direction of the notch 21, and the decoration portion 310 extends along the third edge 213, and is respectively spliced with the first edge 211, the second edge 212, and the third edge 213. In a use state, a hand of a user extends from an open part of the notch 21 into the handle groove 300 to grip the gripping portion 31 and applies a force to the handle member 30 to open the door 1 of the refrigerator.

In addition, in this embodiment, the first region 20a of the front panel 20 is provided with a display region 200. The display region 200 is set to be more transparent than the remaining part of the front panel 20. The display region 200 is configured to display, for example, temperature information or humidity information of different storage compartments of the refrigerator. A length extension direction of the display region 200 is consistent with a length direction in which the decoration portion 310 is exposed on the front side of the door 1. This is beneficial to compactly arranging the user-interface electrical module 11 and the handle member 30 together, which reduces the occupation of the thermal insulation space, and is beneficial to improving the thermal insulation performance of the door 1.

Referring to FIG. 8 with reference to FIG. 4 and FIG. 5, the decoration portion 310 includes an external plane 311 exposed on the front side of the door 1, and the external plane 311 is flush with a front surface of the second region 20b and a front surface of the first region 20a. The decoration portion 310 further includes a baffle wall 312 substantially perpendicular to the external plane 311, and the baffle wall 312 abuts against the third edge 213 of the front door panel 2, to achieve seamless splicing of the decoration portion 310 and the front panel 20.

To make it easier to control the external plane 311 to be flush with the front surface of the second region 20b and the front surface of the first region 20a, the base portion 320 of the gripping portion 31 includes a protrusion 321 protruding toward the front panel 20, and the protrusion 321 engages the third edge 213 and abuts against the front panel 20, as shown in FIG. 4.

During foaming, the temperature of the door 1 may reach 70° C. or more. In this embodiment, the door 1 is used as a door of a freezing compartment of the refrigerator. In a use state of the refrigerator, the temperature inside the door 1 can reach—18° C. or even lower. Due to the temperature difference effect, the front panel 20 covering the front of the user-interface electrical module 11 is deformed to some extent, and regions of two ends of the front panel 20 in the length direction (the Y direction shown in FIG. 2) of the handle groove 300 are deformed toward the direction of the handle groove 300. To reduce interference with the deformed portion of the front panel 20, in this embodiment, the protrusion 321 extends along a partial length of the handle groove 300, and the base portion 320 is provided with an avoidance region 320a on each of two ends of the protrusion 321. The size of the avoidance region 320a in the length direction (the Y direction shown in FIG. 2) of the handle groove 300 is 30 mm. In the avoidance region 320a, a gap P is kept between the front panel 20 and the base portion 320 in an extending direction of the protrusion 321, as shown in FIG. 5.

To save materials of the handle member, in this embodiment, the decoration portion 310 is constructed as a hollow decoration portion 310.

To firmly mount the handle member 30 on the door, in this embodiment, the cover portion 33 includes a mounting portion 330. The door 1 further includes an intermediate element 80 disposed between the cover portion 33 and the user-interface housing 9. A connection member 60 passes through the mounting portion 330 and the intermediate element 80 to be connected to the user-interface housing 9. In this embodiment, the connection member 60 includes a screw.

The mounting portion 330 is formed with a cavity 333 and includes a first mounting wall 331 and a second mounting wall 332 that are disposed opposite to each other and spaced apart. The first mounting wall 331 is formed with two mounting holes 335 in regions at two ends in the length direction of the handle groove 300, and two mounting holes 336 are correspondingly formed in the second mounting wall 332. As shown in FIG. 5, the connection member 60 passes through the first mounting wall 331, the cavity 333, and the second mounting wall 332 to mount the cover portion 33 to the user-interface housing 9. Compared with a single mounting wall, this embodiment increases a total stroke for the connection member 60 to cooperate with the cover portion 33, which is beneficial to improving the stability and firmness of the connection between the two.

The first mounting wall 331 and the second mounting wall 332 extend perpendicular to the depth direction of the handle groove 300. Moreover, the first mounting wall 331 and the second mounting wall 332 are wall bodies that enclose the cavity 333. In the process of mounting the handle member 30, a force of pressing the cover portion 33 in the depth direction (the X direction shown in FIG. 5) of the handle groove 300 is dispersed through the cavity 333. The second mounting wall 332 abuts against the intermediate element 80, and the intermediate element 80 abuts against the user-interface housing 9. The second mounting wall 332 transfers the force of pressing the cover portion 33 to the user-interface housing 9, instead of concentrating the force on one or more mounting ribs, which is more beneficial to reducing the risk of causing damage to related components in the process of mounting the handle member.

To prevent water vapor or dust from entering the accommodating portion 10, a sealing member 800 is disposed on a portion of the intermediate element 80 facing the front panel 20. The sealing member 800 is disposed between the intermediate element 80 and the front panel 20 in a compressed state.

The foregoing describes only one embodiment of the present invention. After modification and combination, the present invention may include more embodiments. For example, in another embodiment of the present invention, the front door panel 2 includes a notch extending to another outer edge 2b of the front door panel 2, and the notch extends along a partial width of the front door panel 2. In another example, the decoration portion 310 fills the entire notch 21 of the front door panel 2, that is, a complete front door panel 2 is formed after the notch 21 is filled up by the decoration portion 310. The handle groove 300 is accessed from the second opening 500 on the side wall 5.

In still another example, in another embodiment of the present invention, the front panel 20 includes a plurality of display regions 200. For example, the plurality of display regions 200 respectively display temperature information of a refrigerating compartment, a freezing compartment, and a variable-temperature compartment. An arrangement direction of the plurality of display regions 200 is consistent with a length direction in which the decoration portion 310 is exposed on the front side of the door 1.

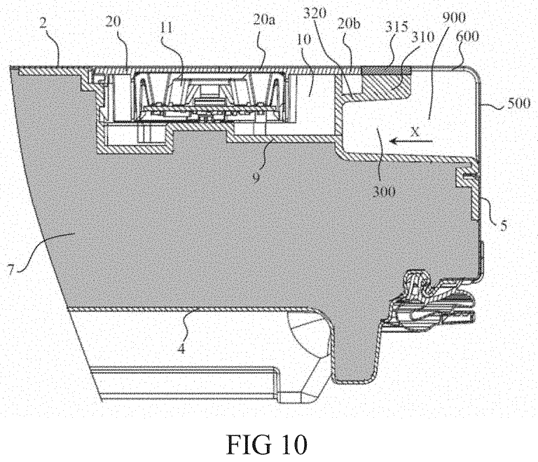

Refer to FIG. 9 and FIG. 10. FIG. 9 is a schematic diagram of a front wall, a side wall, and a user-interface housing according to another embodiment of the present invention; and FIG. 10 is a partial cross-sectional view of a door of a refrigerator according to another embodiment of the present invention. Same or similar structures in this embodiment and the foregoing embodiments are represented by same or similar reference numerals, and have same or similar functions or effects, which is not described herein again. Different from the foregoing embodiments, in this embodiment, the front wall 6 forms the front door panel 2 of the door of the refrigerator and can be touched by a user in a use state. The front wall 6 and the side wall 5 are a one-piece member and formed by extruding a thin metal plate. That is, in this embodiment, the front door panel of the door of the refrigerator is a metal plate.

The front wall 6 includes the first opening 600, and the first opening 600 forms the notch of the front door panel 2. The side wall 5 includes the second opening 500 in communication with the first opening 600. The user-interface housing 9 closes the first opening 600 and the second opening 500 relative to the thermal insulation layer 7. The user-interface housing 9 includes a recess 900 open toward the first opening 600 and the second opening 500, and the recess 900 is configured to access the handle groove 300 located in the user-interface housing 9.

In this embodiment, the front panel 20 is a one-piece front panel, for example, is manufactured from a plastic material. The front panel 20 is spliced with the front door panel 2 to close most of the notch, and the decoration portion 310 extends along an edge of the front panel 20. The front panel 20 includes the first region 20a covering the accommodating portion 10 and the second region 20b covering the base portion 320. The decoration portion 310, the second region 20b, and the first region 20a are arranged side by side in the depth direction (the X direction shown in FIG. 10) of the handle groove 300.

Different from the foregoing embodiments, in this embodiment, the user-interface housing 9 integrally forms the base portion 320 and the decoration portion 310. A decoration strip 315 exposed on the front side of the door 1 is disposed on the decoration portion 310. In this embodiment, the decoration strip 315 is a one-piece metal decoration strip and is attached to the decoration portion 310.

In another embodiment of the present invention, the decoration strip 315 is a plating formed on the surface of the decoration portion 310 exposed on the front side, to form a plating having a color and gloss similar to those of metal.

Various embodiments of individual parts described with reference to FIG. 1 to FIG. 10 may be combined with each other in any given manner to achieve the advantage of the present invention.

The present invention has been described by the foregoing related embodiments, but the foregoing embodiments are only examples for implementing the present invention. It should be noted that the disclosed embodiments do not limit the scope of the present invention. On the contrary, changes and modifications made without departing from the spirit and scope of the present invention fall within the protection scope of the present invention.

The following is a summary list of reference numerals and the corresponding structure used in the above description of the invention:
1 Door;
2 Front door panel;
2a, 2b Outer edges of front door panel;
4 Door liner;
5 Side wall;
6 Front wall;
7 Thermal insulation layer;
9 User-interface housing;
10 Accommodating portion;
11 User-interface electrical module;
20 Front panel;
20a First region;
20b Second region;
21 Notch;
30 Handle member;
31 Gripping portion;
33 Cover portion;
60 Connection member;
80 Intermediate element;
90 Accommodation space;
91 First rear wall;
200 Display region;
211 First edge;
212 Second edge;
213 Third edge;
300 Handle groove;
310 Decoration portion;
311 External plane;
312 Baffle wall;
315 Decoration strip;
320 Base portion;
321 Protrusion;
320a Avoidance region;
330 Mounting portion;
331 First mounting wall;
332 Second mounting wall;
333 Cavity;
335, 336 Mounting holes;
600 First opening;
500 Second opening;
800 Sealing member;
900 Recess;
X Depth direction of handle groove;
Y Length direction of handle groove;
Z Width direction of handle groove; and
P Gap.

1. A door for a refrigerator, the door comprising:
an accommodating portion;
a user-interface electrical module at least partially located in said accommodating portion;
a front panel covering a front of said user-interface electrical module;
a handle groove, said handle groove and said accommodating portion being adjacent in a depth direction of said handle groove; and
a gripping portion located in front of said handle groove in a width direction of said handle groove;
said gripping portion having a decoration portion and a base portion located behind said front panel;
said decoration portion and said front panel being adjacent in said depth direction of said handle groove and being exposed on a front side of the door;
said front panel having a first region covering said accommodating portion and a second region covering said base portion; and
said decoration portion, said second region, and said first region being arranged side by side in said depth direction of the handle groove.

2. The door according to claim 1, further comprising:
a door liner;
a front wall; and
a side wall located between the door liner and the front wall,
said door liner, said front wall, and said side wall defining a thermal insulation space, and said thermal insulation space being filled with a thermal insulation layer;
a user-interface housing being combined with said thermal insulation layer, said accommodating portion being located in said user-interface housing;
said front wall having a first opening, said side wall having a second opening in communication with said first opening; said user-interface housing closing said first opening and said second opening relative to said thermal insulation layer;
said user-interface housing having a recess open toward said first opening and said second opening;
said recess being used for accessing the handle groove located in said user-interface housing, and said decoration portion extends along a whole length of said first opening.

3. The door according to claim 2, wherein said recess, said decoration portion, and said front panel are arranged side by side in the depth direction of the handle groove.

4. The door according to claim 1, wherein said first region of said front panel is provided with at least one display region, said display region being more transparent than a remaining part of said front panel, and a length extension direction of the display region or an arrangement direction of a plurality of display regions being consistent with a length direction in which said decoration portion is exposed on said front side of the door.

5. The door according to claim 1, wherein said decoration portion comprises an external plane exposed on said front side of the door, and said external plane being flush with a front surface of said second region and a front surface of the first region.

6. The door according to claim 1, wherein the size of said decoration portion in said depth direction of said handle groove is not less than 20 mm.

7. The door according to claim 1, further comprising a front door panel facing a user, said front door panel having a notch extending toward an outer edge of said front door panel, said notch extending along a partial length or width of said front door panel, and said decoration portion being located in the notch, extending along a whole length of the notch, fills at least a part of the notch.

8. The door according to claim 7, wherein a part of said front door panel is constructed as said front panel, said front door panel having a first edge and a second edge that are disposed in parallel and spaced apart, and a third edge connecting said first edge and said second edge, said first edge and said second edge respectively constitute two boundaries of said notch in a length direction of said notch, the third edge constitutes a boundary of said notch in a width direction of said notch, and said decoration portion extends along said third edge, and is respectively spliced with said first edge, said second edge, and said third edge.

9. The door according to claim 8, wherein said user-interface housing is combined with said thermal insulation layer, said user-interface housing has an accommodation space in communication with said accommodating portion located in said user-interface housing, and said user-interface electrical module is mountable or removable through said accommodation space; and said door has a cover portion configured to close said accommodating portion, said cover portion is connected to said base portion, and said cover portion and said gripping portion are constructed as a one-piece member detachably mounted in the accommodation space.

10. The door according to claim 9, wherein said gripping portion and said cover portion are constructed as a one-piece metal member.

11. The door according to claim 9, wherein said base portion comprises a protrusion protruding toward said front panel, and said protrusion engages said third edge and abuts against said front panel.

12. The door according to claim 11, wherein said protrusion extends along a partial length of said handle groove, and said base portion is provided with an avoidance region on each of two ends of said protrusion.

13. The door according to claim 9, wherein the decoration portion comprises said external plane exposed on said front side of the door, and a baffle wall substantially perpendicular to said external plane, and said baffle wall abuts against said third edge.

14. The door according to claim 10, wherein said decoration portion is a hollow decoration portion.

15. The door according to claim 9, wherein said cover portion comprises a mounting portion, said mounting portion being formed with a cavity and has a first mounting wall and a second mounting wall that are disposed opposite to each other and spaced apart, and a connection member passing through said first mounting wall, said cavity, and said second mounting wall to mount said cover portion to said user-interface housing.

16. The door according to claim 15, further comprising an intermediate element disposed between said cover portion and said user-interface housing, a sealing member being disposed on a portion of said intermediate element facing said front panel, and said connection member passing through said mounting portion and said intermediate element connected to said user-interface housing.

17. The door according to claim 7, wherein said front door panel is a one-piece front door panel, said front panel is spliced with said front door panel to enclose most of said notch, and said decoration portion extends along an edge of said front panel.

18. The door according to claim 17, wherein said user-interface housing is combined with said thermal insulation layer, and said user-interface housing is integrally formed with said base portion and said decoration portion.

19. The door according to claim 18, further comprising a decoration strip on the decoration portion exposed on said front side of the door.

20. The door according to claim 19, wherein said decoration strip is a one-piece metal decoration strip.
